(19) United States
(12) Patent Application Publication
(10) Pub. No.: US 2006/0093721 A1
(43) Pub. Date: May 4, 2006

(54) French cruller products and methods of making same

(76) Inventors: Robert Pitts, Quincy, MA (US); Kathleen LeClair, North Attleboro, MA (US); Patricia Vincente, Lincoln, RI (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/975,861

(22) Filed: Oct. 28, 2004

(51) Int. Cl. A21D 10/00

(52) U.S. Cl. 426/549

(57) ABSTRACT

French crullers comprising at least about 10% egg yolk and at least about 15% starch are further provided with a flavoring such as chocolate, vanilla, fruits, cocoa and combinations thereof. These crullers, with or without the flavoring can be formed as cruller globules by extruding the dough through orifices in a plunger.

### BACKGROUND

French crullers are a well-known “baked good,” which can be distinguished from donuts, for example, by the French crullers' standard spiral-ring shape and by their composition, which includes a substantial concentration of egg yolk and starch and is substantially free of flour.

It is well known that French cruller formulations are very sensitive to variations in composition; variations from the accepted formulations will often result in the final product having a taste that is unacceptable to a substantial portion of consumers.

The spiral-ring shape, which has long been accepted throughout industry, is believed to be well-suited for French crullers, as French crullers tend to naturally have very irregular surfaces. Consequently, if one attempts to form a cruller into a plain ring (similar to a donut), for example, the resultant product will tend to have a flawed appearance due to the irregular appearance.

Accordingly, very little variation from accepted practices is generally found or attempted with respect to French crullers in terms of either flavorings or shape.

### SUMMARY

A French cruller formulation comprising at least about 10% egg yolk and at least about 59% starch is further provided with a flavoring such as chocolate, vanilla, fruits, and combinations thereof. The formulation can then be mixed with water to form a dough, which is then shaped by a plunger and orifice into a traditional spiraled-ring cruller shape and fried to produce a cruller ready for consumption.

Alternatively, French crullers, with or without the flavoring can be formed as French cruller globules by using a plunger to extrude the dough through orifices in a stencil (e.g., a ring with orifices).

The French cruller flavors resulting from the addition of these flavorings have been found to be very favorable. And the final globule shape produced from a fried French cruller product extruded through an orifice has also been found to be aesthetically attractive.

### BRIEF DESCRIPTION OF THE DRAWINGS

In the accompanying drawings, described below, like reference characters refer to the same or similar parts throughout the different views. The drawings are not necessarily to scale, emphasis instead being placed upon illustrating particular principles of the methods and apparatus characterized in the Detailed Description.

FIG. 1 is an image of a cruller depositor.

FIG. 2 is an image of a cruller plunger.

FIG. 3 is a magnified image of the cruller plunger of FIG. 2.

FIG. 4 is an image of a French cruller produced via the plunger of FIGS. 2 and 3.

FIG. 5 is an image of a plunger for forming globules.

FIG. 6 is a magnified image of the plunger of FIG. 5.

FIG. 7 is an image of a French cruller globule formed using the plunger of FIGS. 5 and 6.

### DETAILED DESCRIPTION

The unique French cruller products of this disclosure include French crullers that include a flavoring, such as chocolate, vanilla, fruits (such as strawberry or apple), cocoa, and combinations thereof, and/or that have the shape of substantially round globules. French crullers can be distinguished from donuts and other baked goods, for example, by the concentrations of egg yolk (e.g., at least about 10 weight-%) and starch (e.g., at least about 59 weight-%) in French crullers as well as by the substantial absence of flour in French crullers. The starch and egg yolk in the formulation make the formulation very sensitive to formula variation.

The French cruller composition can be conceptually divided into a foundation and the unique flavoring. The concentration of each of the various ingredients in an embodiment of the foundation is provided in the following table:

| | French Cruller Foundation |
|---|---|
| Ingredients: | Formula (weight %): |
| Gelatinized Wheat Starch | 41.10 |
| Non-Pre-Gelatinized Wheat Starch | 15.00 |
| All-Purpose Vegetable Shortening | 14.00 |
| Dried Egg Yolks | 11.00 |
| Dried Egg Albumen | 5.00 |
| Sodium Caseinate | 4.50 |
| Corn Starch | 3.50 |
| Mono & Diglycerides | 3.00 |
| Salt | 1.00 |
| Nonfat Dry Milk | 0.80 |
| Sodium Bicarbonate | 0.55 |
| Sodium Aluminum Phosphate | 0.55 |
| | 100.00 |

Concentration ranges for the ingredients in other embodiments of the foundation are typically ±5% of the concentrations, listed above. Though, in other embodiments, the concentration of any of the ingredients can be within a range of ±10%, or even ±20% of the concentration listed above. The concentration of the flavoring in the overall formulation (combining the flavoring with the foundation) is generally less than about 1 weight-%, though high concentrations can be used (e.g., about 5% for cocoa or where other less-intense flavorings are used). Combinations of flavorings can also be used (e.g., apple cinnamon), and the fruit can be provided as real fruit bits.

In addition to or in place of natural flavoring, the flavoring(s) can include an artificial flavoring. Suitable artificial bakery flavorings are available in a wide range of flavors (including, e.g., strawberry) from Flavorchem Corp., Downers Grove, Ill., USA, which designates the bakery flavors for customers by reference to the natural flavor (e.g., strawberry) that the artificial flavor substantially matches in terms of taste. Common carriers for the artificial flavoring are propylene glycol and alcohol. The term, “artificial [x] flavor” is routinely used by suppliers and producers in the food industry to characterize non-natural compositions that have a flavor that mimics a natural flavor, x, which can be, e.g., apple, strawberry, etc. Further, 21 CFR 101.22(a)(1) defines “artificial flavor/flavoring” as follows:
The term artificial flavor or artificial flavoring means any substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof. Artificial flavor includes the substances listed in Secs. 172.515(b) and 182.60 of this chapter except where these are derived from natural sources.
   On the other hand, “natural flavor/flavoring” is defined in 21 C.F.R. 101.22(a)(3) as follows:
The term natural flavor or natural flavoring means the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. Natural flavors include the natural essence or extractives obtained from plants listed in Secs. 182.10, 182.20, 182.40, and 182.50 and part 184 of this chapter, and the substances listed in Sec. 172.510 of this chapter.

The dough that forms the French crullers is made by mixing a dry formulation with water. The temperature of water to be mixed with the dry formulation can be determined as follows. The room temperature and dry formulation temperature are both recorded. The room temperature; the dry-formulation temperature and a friction factor of 15° F. (8.3° C.) (to account for frictional heat generated during extended mixing) are then added, and their sum is subtracted from 270° F. (132° C.). The difference of 270° F. (132° C. and the combined temperature and dry formulation temperatures will be the temperature at which the water should be set to achieve a final dough temperature of 90° F. (32° C.) after the water is mixed with the dry formulation. However, the water temperature is generally maintained to not exceed 130° F. (54° C.).

For 5 pounds of dry formulation, 8 pounds and 12 ounces of water is added. The resulting dough is sufficient to form 13 dozen crullers. For greater or lesser batches of dry formulation, proportionately more or less water is added. The dry formulation and water are mixed as follows. First, half of the water is poured into a 40-quart mixing bowl. The dry mix is added next, and then the remaining water is added. The resulting dough is mixed using a Hobart 80-quart, four-speed mixer at a 2^{nd} speed (96 rpm) for two minutes. The clutch of the mixer is disengaged, and the mixer is returned to a 1^{st} speed (55 rpm). The bowl is then lowered, and the paddle, sides and bottom of the bowl are scraped. The bowl is again raised, and the dough is mixed for another five minutes, this time at a 3^{rd} speed (183 rpm). The mixer is then returned to a 1^{st} speed and is then shut off. The bowl is lowered, and the paddle and the sides of the bowl are scraped. The temperature of the dough is measured, and the dough is left to sit in the bowl for five minutes.

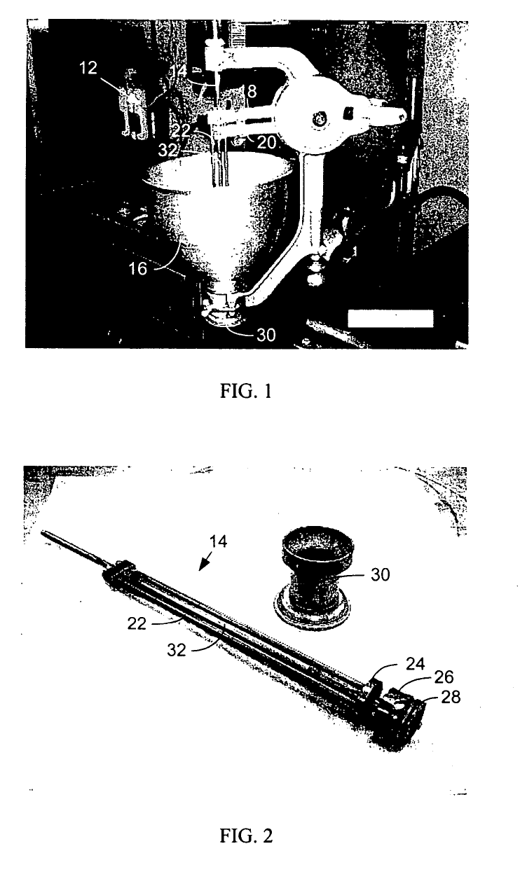

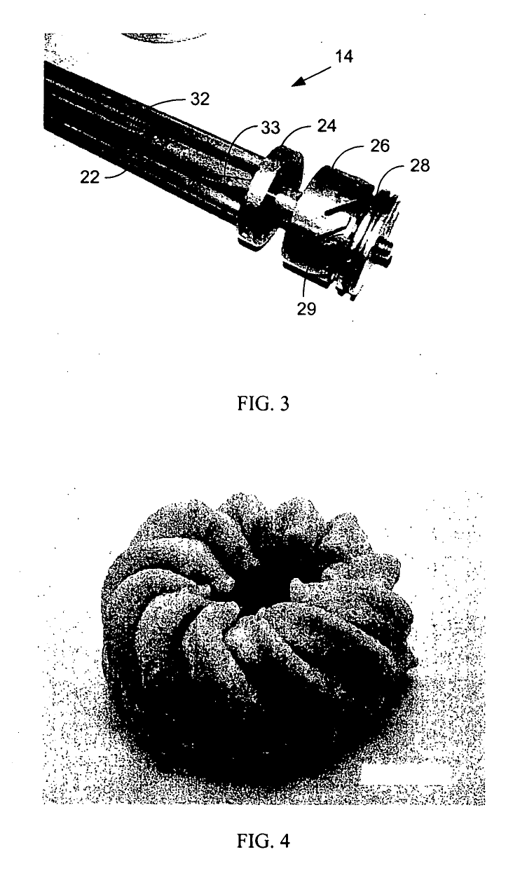

French crullers with a traditional, spiraled cruller shape are formed by shaping the dough using a depositor machine 12, illustrated in FIG. 1, utilizing a cruller plunger 14, as illustrated in FIGS. 2 and 3. The dough is placed in the hopper 16, and the dough can continually be pushed down in the hopper 16 to prevent formation of air pockets in the dough. The plunger 14 is controlled by two displaceable arms 18 and 20. A first arm 18 is coupled with a frame connected with the top plate of the plunger, and a second arm 20 is separately coupled with a shaping ring 26 and a bottom piece 28 having a dome-shaped top surface 29. Dough fills into the plunger 14 between the top plate 24 and the bottom piece 28 in the hopper 16. The second arm 20 lowers the bottom piece 28 and shaping ring 26 so that the contoured orifice between the bottom piece 28 and shaping ring 26 (jointly serving as a stencil for the extrusion of French crullers) is below a cylinder 30 extending from the bottom of the hopper 16. The top plate 24 is then lowered through the cylinder 30 to force dough through the orifice between the shaping ring 26 and bottom piece 28, thereby forming the spiraled French cruller ring. The central rod 32 includes a groove 33 that interfaces with a fixed guide surface on the top plate 24 so that the shaping ring 26 and bottom piece 28 are rotated as the top plate 24 and bottom piece are drawn together to facilitate formation of the spiral shape. The shaped French cruller will have a weight of about 1.25 ounces (35 g).

A fryer filled with shortening at 375° F. (191° C.) is positioned below the plunger so that the extruded crullers fall into the shortening crown-side down; the top surface of the shortening is positioned 1.5-2 inches (3.8-5.1 cm) beneath the reach of the fully extended plunger. A donut screen is placed in the fryer before the extruded French crullers start dropping into the fryer. The French crullers are fried for two minutes, turned and submerged for another three minutes in the fryer. The French crullers are lifted out of the fryer after raising the donut screen. The final French cruller product, after frying, is illustrated in FIG. 4.

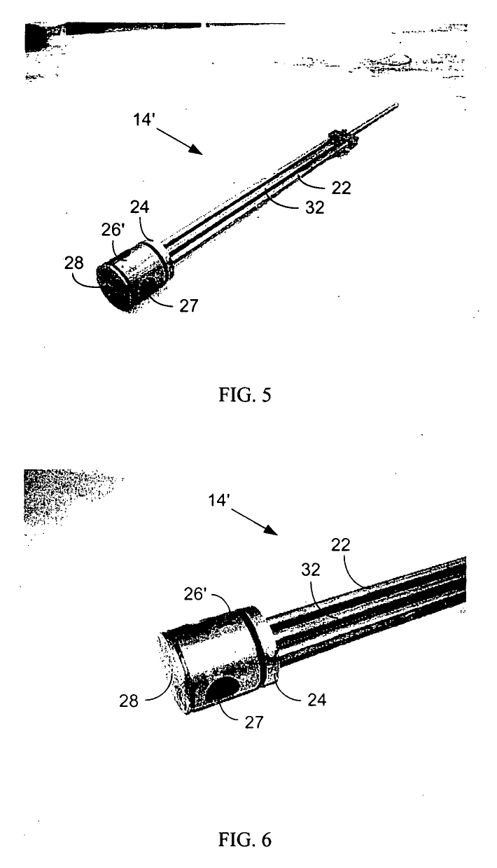

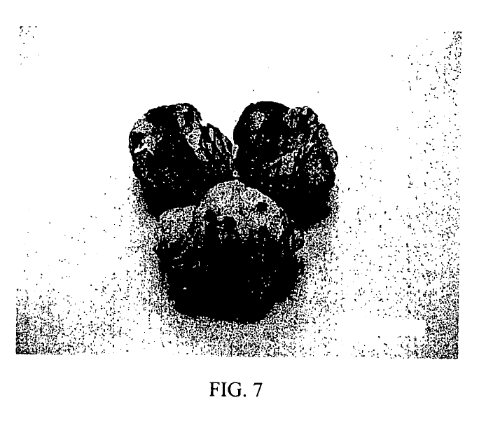

French crullers having a globular shape (i.e., an irregular, roughly spherical shape) can likewise be produced using the same apparatus as above, with the exception of substituting a new plunger. The dry formulation and water are mixed in the same ratio as above [i.e., 5 pounds (2.3 kg) of dry formulation per 8 pounds, 12 ounces (4.0 kg) of water]. And the mixing procedure is likewise the same as above. The plunger 14 used to produce these globules is illustrated in FIGS. 5 and 6, wherein the shaping ring 26′, which is integrated with the bottom piece 28, has three orifices 27 around its perimeter through which the dough is extruded as balls when the distance between the bottom piece 28 and the top plate 24 is decreased. The raw weight of each of the four dough balls is about 0.41 to about 0.45 ounces (about 12 to about 13 g). And these dough balls are then fried by submerging them in the shortening at 375° F. (191° C.) for five minutes to produce the fried French cruller globules. The French cruller globules can, optionally, then be coated in drizzled chocolate (or other flavoring) to produce a final product, as illustrated in FIG. 7.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various changes in form and details may be made therein without departing from the scope of the invention.

What is claimed is:

1. A French cruller composition comprising:
at least about 10 weight-% egg yolk;
at least about 59 weight-% starch; and
flavoring selected from the group consisting of chocolate, vanilla, fruit flavorings, and combinations thereof.

2. The French cruller composition of claim 1, wherein the composition is substantially free of flour.

3. The French cruller composition of claim 1, wherein the fruit flavorings in the group from which the flavoring is selected are apple and strawberry flavorings.

4. The French cruller composition of claim 1, wherein the flavoring is less than 1 weight-% of the French cruller composition.

5. The French cruller composition of claim 1, wherein the composition is in the form of a dry formulation.

6. The French cruller composition of claim 1, wherein the composition is in a fried form.

7. The French cruller composition of claim 1, wherein the flavoring includes a natural flavoring.

8. The French cruller composition of claim 1, wherein the flavoring includes an artificial flavoring.

9. A French cruller composition comprising:
a foundation including:
39.045 to 43.155 weight-% gelatinized wheat starch;
14.25 to 15.75 weight-% non-pre-gelatinized wheat starch;
13.3 to 14.7 weight-% vegetable shortening;
10.45 to 11.55 weight-% egg yolk measured on a dry basis;
4.75 to 5.25 weight-% egg albumen measured on a dry basis;
4.275 to 4.725 weight-% sodium casseinate;
3.325 to 3.675 weight-% corn starch;
2.85 to 3.15 weight-% monoglycerides and diglycerides;
0.95 to 1.05 weight-% salt;
0.76 to 0.84 weight-% non-fat dry milk measured on a dry basis; and
0.5225 to 0.5775 weight-% sodium bicarbonate; and
0.5225 to 0.5775 weight-% sodium aluminum phosphate; and
flavoring selected from the group consisting of chocolate, vanilla, fruits, cocoa and combinations thereof.

10. The French cruller composition of claim 9, wherein the fruits in the group from which the flavoring is selected are apple and strawberry.

11. The French cruller composition of claim 9, wherein the composition is in the form of a dry formulation.

12. The French cruller composition of claim 9, wherein the composition is in a fried form.

13. The French cruller composition of claim 9, wherein the flavoring is less than 1 weight-% of the French cruller composition.

14. The French cruller composition of claim 9, wherein the flavoring includes a natural flavoring.

15. The French cruller composition of claim 9, wherein the flavoring includes an artificial flavoring.

16. A method for making a French cruller product comprising:
providing dough comprising water, at least about 10 dry-weight-% egg yolk, and at least about 15 dry-weight-% starch;
forcing the dough through apertures in a stencil via displacement of a plunger to produce balls of dough having no dimensions greater than about 4 cm; and then frying the balls of dough.

17. The method of claim 16, wherein each ball of dough has a mass of about 0.41 to about 0.45 ounces before frying.

18. The method of claim 16, wherein each ball of dough has a mass of about 0.33 to about 0.43 ounces after frying.

19. The method of claim 16, wherein the stencil is a ring and wherein the dough is forced through a plurality of apertures in one or more sidewalls of the ring, the sidewall(s) positioned about an axis along which the plunger is displaced.

20. The method of claim 16, wherein the dough is substantially free of flour.

21. The method of claim 20, wherein the dough further comprises flavoring selected from the group consisting of chocolate, vanilla, fruits, cocoa and combinations thereof.

23. A method for making a French cruller product comprising
providing dough comprising water, at least about 10 dry-weight-% egg yolk, at least about 59 dry-weight-% starch, and flavoring selected from the group consisting of chocolate, vanilla, fruit flavors, and combinations thereof;
displacing a plunger to displace dough through an orifice, wherein the dough is shaped into a spiraled ring shape; and then
frying the shaped ring of dough.

24. The method of claim 23, wherein the dough is substantially free of flour.
